(19) United States
(12) Patent Application Publication
(10) Pub. No.: US 2009/0211138 A1
(43) Pub. Date: Aug. 27, 2009

(54) Display Article

(76) Inventors: Allan Burman, Queensland (AU); Albert De Boer, Western Australia (AU)

Correspondence Address: DILWORTH & BARRESE, LLP, 1000 WOODBURY ROAD, SUITE 405, WOODBURY, NY, 11797, US

(21) Appl. No.: 12/083,796

(22) PCT Filed: Oct. 13, 2006
(86) PCT No.: PCT/AU2006/001524

§ 371 Date: Apr. 2, 2009

(30) Foreign Application Priority Data
Oct. 19, 2005 (AU) 2005905774

(51) Int. Cl. A47G 1/06; B44C 5/00

(52) U.S. Cl. 40/700; 428/13

(57) ABSTRACT

A display article (10) has a single indicia plate (11) having indicia formed by cut-outs (12) in the indicia plate (11) and one or more plates (13, 14) attached to the indicia plate (11) which are opaque, transparent or translucent.

This invention relates to a display article which is especially directed to a display plaque, name plate, trophy or decorative piece of artwork forming part of a window or door or which may be attached to a suitable support surface such as a wall.

U.S. Pat. No. 5,415,902 refers to a display plaque. One plate is transparent which has indicia formed thereon by silk screening or a reverse printing method. The transparent plate is attached to an opaque plate which is itself attached to a rear or backing plate. The opaque plate in one particular embodiment has an aperture or recess which receives the transparent plate or indicia plate. The indicia plate is fixed to the backing plate. The opaque plate may carry other indicia such as names or symbols. The essence of the invention of U.S. Pat. No. 5,415,902 is a decorative effect achieved by cutting the transparent plate and the opaque plate so that they fit together flush to form an abutment line that is serpentine in shape.

The serpentine abutment line is an aesthetic effect that only has limited appeal. Also forming indicia by silk screening or a reverse printing method is expensive and achieves an aesthetic effect which is already well known being similar to other display plaques having indicia formed on a vertical surface exemplified by printed letters or a photograph such as described in a casket ornamental display plaque described in U.S. Pat. No. 6,557,222. Similar comments apply to indicia formed on a vertical surface on decorative plaques described in U.S. Pat. Nos. 3,414,056, 4,125,655 and 4,190,691.

It is therefore an object of the invention to provide a display article which achieves a unique decorative effect that has hot been achieved in the prior art discussed above.

The display article of the has:

(i) a single indicia plate having indicia formed by cut outs in the indicia plate constituting a front plate of the display article.

(ii) a second plate located rearwardly of the single indicia plate formed from coloured material; and

(iii) a third plate located rearwardly of the second plate which is formed from reflective material characterised in that each of plates (i), (ii) and (iii) are arranged adjacent to each other in separate planes with the only indicia in the display article being formed in the indicia plate or surrounding the indicia plate wherein the colour of the second plate is reflected from the third plate through said indicia of the indicia plate to provide an aesthetic effect.

These also may be provided a backing plate or sheet for plates (i), (ii) and (iii).

The indicia may be formed by laser cutting of the indicia plate which in this arrangement may be formed from stainless steel or other suitable metal such as aluminium. It will also be appreciated that the indicia plate may also be formed from plastics material if required. Laser cutting is a relatively quick and inexpensive method of forming the indicia in the indicia plate.

The display article also may have a mounting base for the backing plate or sheet and the backing base may be formed from natural rock, concrete, granite, marble or stone. The mounting base may also form a fabricated stand or may have a hollow recess or interior for containing cremated ashes of one or more loved ones or mementoes or other articles of memorabilia. In one embodiment the mounting base may form an urn with the display article or plaque attached thereto. In this arrangement the mounting base may have any suitable shape.

In another embodiment the mounting base could include a solar dome or solar electric panel coupled to LEDs (light emitting diodes) or other lighting systems.

Therefore from the foregoing it will be appreciated that the mounting base may have a three dimensional shape such as a cuboid, sphere or triangular or rectangular prism. In this embodiment the display article may have the backing sheet or plate attached to the mounting base. The backing sheet or plate may be formed of ceramic tiles or a sheet formed of ceramic material. Another example of a mounting base is a statue, clock, book or article of furniture.

The indicia formed in the indicia plate by the preferred method of laser cutting can be of any particular font or style as may be required. In another arrangement the solid indicia which are cut out of the indicia plate may be fixed to a surround portion of the indicia plate by any suitable means which includes welding or using appropriate fasteners. The indicia may have other decorative adornments attached thereto such as photographs, statuettes, flower designs and the like. The decorative adornments may be made from any suitable material such as bronze, stainless steel or copper.

Reference may now be made to a preferred embodiment of the invention as shown in the attached drawings wherein:

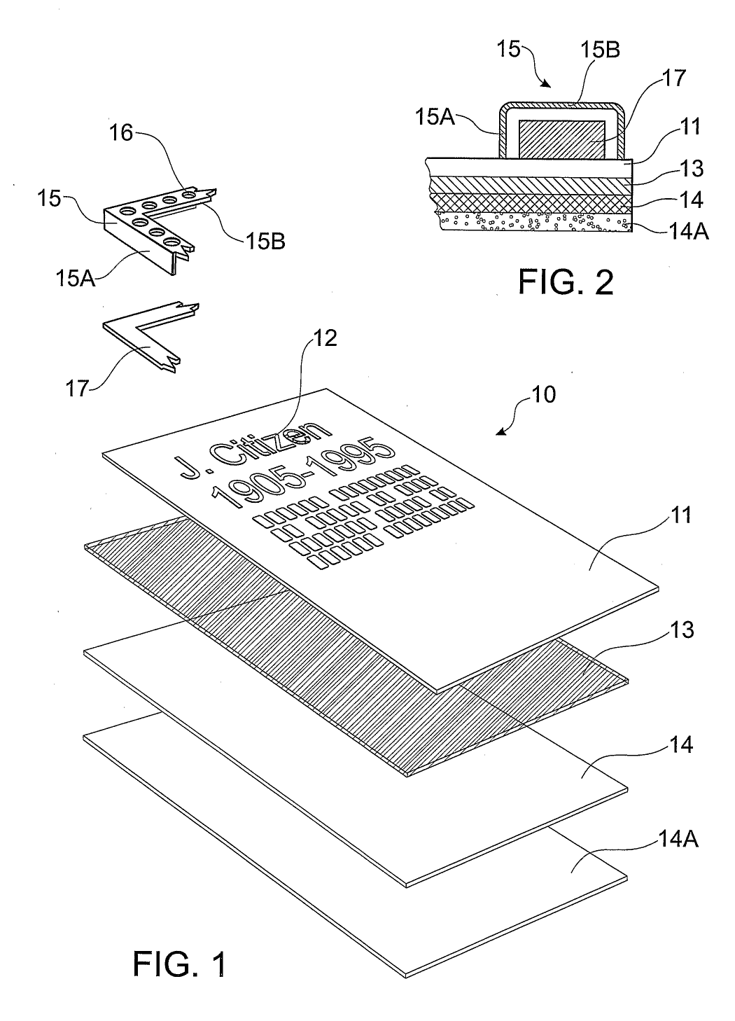

FIG. 1 is a display article of the invention formed by three plates attached to each other;

FIG. 2 is a section through the line A-A of FIG. 1;

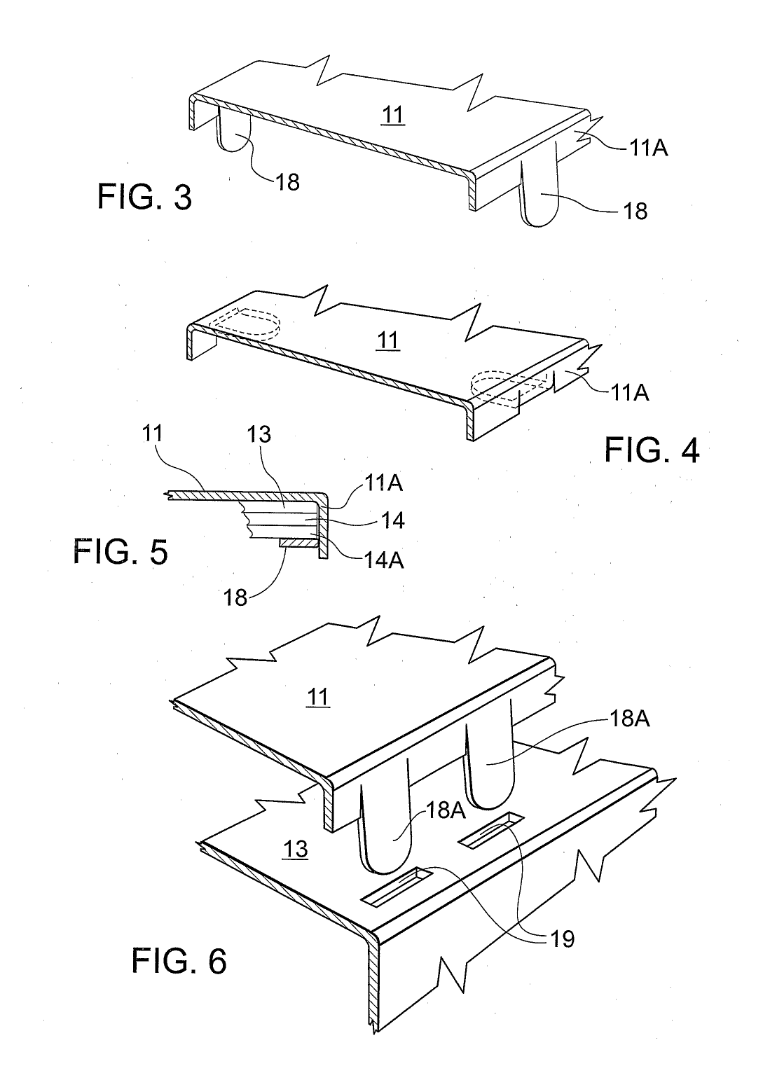

FIGS. 3, 4, 5 and 6 are perspective or three dimensional drawings showing one means of attachment of the plates in the display article.

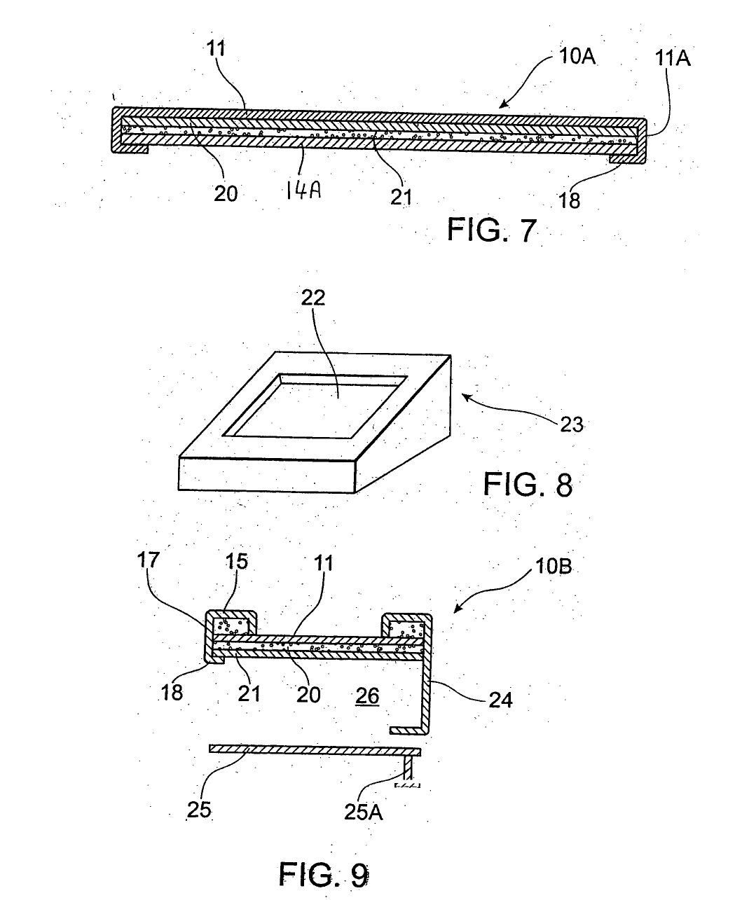

FIG. 7 is a sectional view of a display article formed using the attachment means of FIGS. 3, 4, 5 and 6.

FIG. 8 is an example of a bevelled block useful as a mounting base.

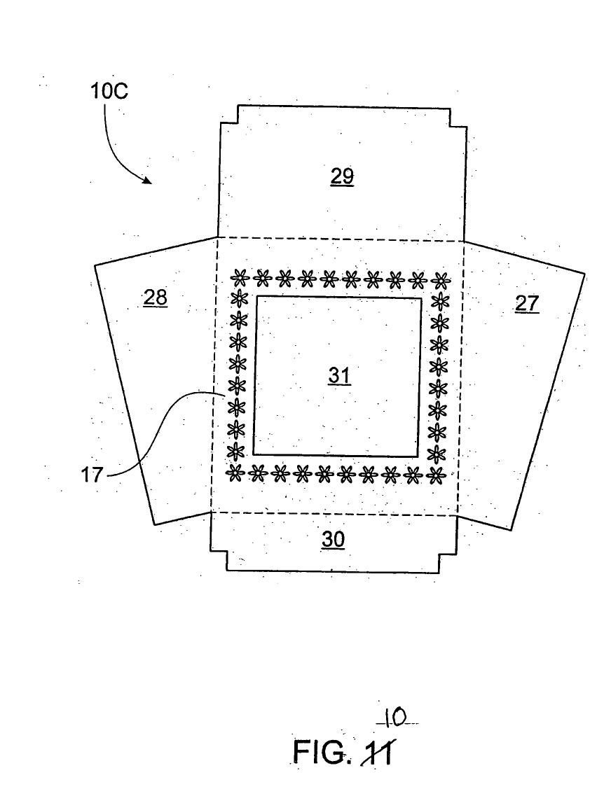

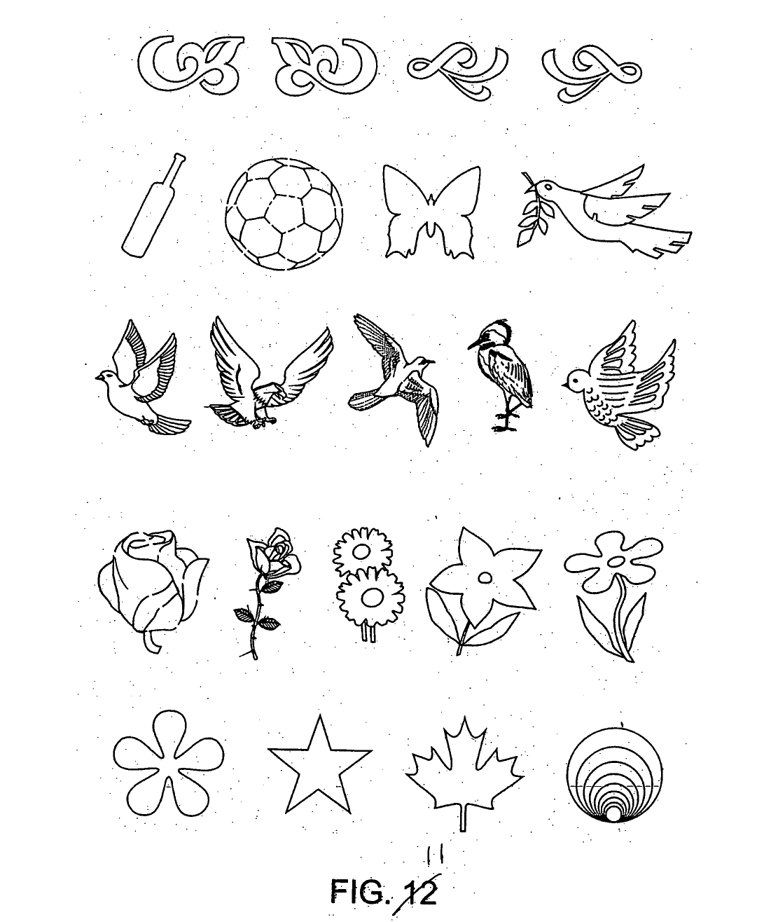

FIG. 9 is a sectional view of another embodiment of the invention wherein the display, article is to be used as a plaque urn;

FIG. 10 is a plan view of another bevelled mounting base forming a display article of the invention, and

FIG. 11 refers to various types of fonts that may be used in the indicia formed in the indicia plate.

In FIG. 1 the display article 10 has an indicia plate 11 having indicia 12 formed by laser cutting of plate 11 which is preferably formed from stainless steel. There is also provided a plate 13 formed of translucent material such as glass or plastics material which is attached to another reflective plate 14 which may be formed from ceramic material, mirror or polished stainless steel. Plate 13 is formed of coloured material and thus a portion of the incident light is reflected by the reflective plate 14 if made from transparent material or even translucent material to shine through indicia 12 to achieve a unique aesthetic effect. In another arrangement plate 13 may be formed of opaque material which is coloured such as ceramic tile and this colour highlights indicia 12. There also may be provided a base plate 14A made from stainless steel which may be dispensed with when plate 14 is formed from stainless steel.

It will also be appreciated that plates 11, 12, 13 and 14 may be formed of more than one component of different colours or textures.

In FIG. 1 there is also shown a peripheral frame 15 of part channel shape with one flange 15A shorter than the web 15B made suitably from stainless steel which may have indicia 16 formed thereon preferably by cut outs to enhance the unique aesthetic effect formed by the display article of the invention. The frame 15 may be used to hold or clamp the plates 11, 13, 14 and 14A together as shown hereinafter. There also may be provided a support or backing frame 17 if required Which also may be formed of coloured transparent, translucent or opaque material. Suitably the indicia 12 and 16 may be identical if required.

In FIG. 2 there is shown a section through the periphery of the assembled plaque 10 showing the frame 15 in another variant is of channel shape where flanges 15A and 15B are of equal width enclosing support frame 17 and located on top of indicia plate 11 and plate 13.

In FIGS. 3 to 5 there is shown an alternative method of attachment of plates 11, 13, 14 and 14A wherein indicia plate 11 is provided with lugs 18 which may be folded inwardly as shown in FIG. 4 to retain plates 12, 13, 14 and 14A as shown in FIG. 5. In this embodiment indicia plate 11 may have a peripheral flange 11A.

FIG. 6 shows a variant to the embodiment of FIGS. 3 to 5 where lugs 18A of indicia plate 11 extend through slots 19 in plate 13 and are then bent inwardly to hold plates 11, 13, 14 and 14A together.

FIG. 7 is a sectional view of a plaque 10A of the invention constructed as shown in FIGS. 3 to 6. Plaque 10A has coloured plate 20, reflective plate 21, indicia plate 11 and backing plate 14A all held in by folded lugs or tabs 18.

FIG. 8 is a three dimensional view of a bevelled mounting base 23 having aperture 22 for mounting a plaque of the invention (not shown). Mounting base 23 may have a hollow interior for location of ashes or other memorabilia.

FIG. 9 show a sectional view of plaque 10B of the invention similar to FIG. 2 but having an attachment lug 24 to be attached to a bottom plate 25. There is thus provided a hollow space 26 so that plaque 10B may be used as an urn. Bottom plate 25 may be attached to a support (not shown) by fastener 25A.

FIG. 10 shows a plan view of a pattern for another plaque 10C having sides 27 and 28 and ends 29 and 30 which surround indicia plate 31. Each of sides 27 and 28 and ends 29 and 30 may be folded inwardly to form a hollow space for a plaque urn.

FIG. 11 is self explanatory and refers to various types of font used as indicia.

It will be appreciated from the foregoing that the display article of the invention may achieve a unique aesthetic effect due to the colour from plate 13 being reflected from plate 14 or being seen through the cut outs of the indicia and thus because of this the invention clearly has a demonstrable advantage over the prior art.

1. A display article having:
(i) a single indicia plate having indicia formed by cut outs in the indicia plate constituting a front plate of the display article;
(ii) a second plate located rearwardly of the single indicia plate formed from coloured material; and
(iii) a third plate located rearwardly of the second plate which is formed from reflective material, wherein
each of plates (i), (ii) and (iii) are arranged adjacent to each other in separate planes with the only indicia in the display article being formed in the indicia plate or surrounding the indicia plate, and
the colour of the second plate is reflected from the third plate through said indicia of the indicia plate to provide an aesthetic effect.

2. A display article as claimed in claim 1 wherein the cut outs in the single indicia plate are formed by laser cutting of the indicia plate which is formed from metal.

3. A display article as claimed in claim 1 also including a backing plate or sheet.

4. A display article as claimed in claim 3 wherein there is provided a mounting base attached to the backing sheet or plate.

5. A display article as claimed in claim 4 wherein the mounting base has a three dimensional shape including a fabricated stand or having a hollow recess or interior.

6. A display article as claimed in claim 5 wherein the mounting base includes a solar dome or solar electric panel coupled to LEDs or other lighting systems.

7. A display article as claimed in claim 1 wherein solid indicia of the single indicia plate which are cut out therefrom are incorporated in a surround or peripheral position of the indicia plate.

8. A display article as claimed in claim 7 wherein the solid indicia are welded or bonded to said surround or peripheral position.

9. A display article as claimed in claim 1 having a peripheral frame adapted to clamp the single indicia plate and the second plate and third plate together.

10. A display article as claimed in claim 9 wherein the peripheral frame also has a plurality of cut-outs.

11. A display article as claimed in claim 1 having a peripheral frame which is located on top of the single indicia plate.

12. A display article as claimed in claim 1 wherein the single indicia plate is provided with attachment lugs which are folded inwardly to retain said single indicia plate and said second and third plates.

13. A display article as claimed in claim 12 wherein the attachment lugs extend through slots in said second sheet before being folded inwardly.

14. A display article as claimed in claim 1 wherein the indicia plate has a plurality of peripheral panels adapted to be folded downwardly to form a hollow space for enclosing the second plate and third plate.

15. A display article as claimed in claim 2 also including a backing plate or sheet.

16. A display article as claimed in claim 15 wherein there is provided a mounting base attached to the backing sheet or plate.

17. A display article as claimed in claim 16 wherein the mounting base has a three dimensional shape including a fabricated stand or having a hollow recess or interior.

18. A display article as claimed in claim 17 wherein the mounting base includes a solar dome or solar electric panel coupled to LEDs or other lighting systems.

19. A display article as claimed in claim 2 wherein solid indicia of the single indicia plate which are cut out therefrom are incorporated in a surround or peripheral position of the indicia plate.

20. A display article as claimed in claim 3 wherein solid indicia of the single indicia plate which are cut out therefrom are incorporated in a surround or peripheral position of the indicia plate.
